(19) United States
(12) Patent Application Publication
(10) Pub. No.: US 2009/0063827 A1
(43) Pub. Date: Mar. 5, 2009

(54) PARALLEL PROCESSOR AND ARITHMETIC METHOD OF THE SAME

(76) Inventor: Shunichi ISHIWATA, Urayasu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/197,663

(22) Filed: Aug. 25, 2008

(30) Foreign Application Priority Data
Aug. 28, 2007 (JP) 2007-221463

(51) Int. Cl. G06F 9/302

(52) U.S. Cl. 712/221; 712/E09.017

(57) ABSTRACT

A parallel processor includes a fetch unit configured to hold a processor instruction having a composite arithmetic instruction with repeat designation and a sync instruction, a decoder unit configured to decode the processor instruction, a plurality of pipeline arithmetic units configured to execute arithmetic operations parallel on the basis of the composite arithmetic instruction, pipeline connection between the pipeline arithmetic units being controlled in accordance with the sync instruction, and a sync control unit equipped between the fetch unit and the decoder unit, and configured to control an execution start timing of the pipeline connection between the pipeline arithmetic units in accordance with the sync instruction.

### CROSS-REFERENCE TO RELATED APPLICATIONS

This application is based upon and claims the benefit of priority from prior Japanese Patent Application No. 2007-221463, filed Aug. 28, 2007, the entire contents of which are incorporated herein by reference.

### BACKGROUND OF THE INVENTION

1. Field of the Invention

The present invention relates to a parallel processor having a pipeline arithmetic unit and an arithmetic method of the parallel processor.

2. Description of the Related Art

To improve the throughput of arithmetic processing of a processor, several means are used to increase the number of instructions to be executed at the same time (e.g., Jpn. Pat. Appln. KOKAI Publication No. 2000-293509). However, although a superscalar processor with out-of-order execution, for example, executes parallel arithmetic processing by using a reorder buffer, the processor requires a large area, complicated configuration, high cost, and large power consumption.

### BRIEF SUMMARY OF THE INVENTION

A parallel processor according to the first aspect of the present invention comprising: a fetch unit configured to hold a processor instruction having a composite arithmetic instruction with repeat designation and a sync instruction; a decoder unit configured to decode the processor instruction; a plurality of pipeline arithmetic units configured to execute arithmetic operations parallel on the basis of the composite arithmetic instruction, pipeline connection between the pipeline arithmetic units being controlled in accordance with the sync instruction; and a sync control unit equipped between the fetch unit and the decoder unit, and configured to control an execution start timing of the pipeline connection between the pipeline arithmetic units in accordance with the sync instruction.

An arithmetic method of a parallel processor which has a sync control unit equipped between the fetch unit and the decoder unit according to the second aspect of the present invention comprising: causing the fetch unit to fetch a first instruction for a first pipeline arithmetic unit; causing the sync control unit to perform synchronous queuing of the first instruction; causing the decoder unit to decode the first instruction, and a register file to fetch the first instruction; causing the first pipeline arithmetic unit to execute a plurality of arithmetic operations parallel on the basis of the first instruction; causing the fetch unit to fetch a second instruction for a second pipeline arithmetic unit simultaneously with the synchronous queuing of the first instruction; and causing the sync control unit to control an execution start timing of pipeline connection with the second pipeline arithmetic unit.

### BRIEF DESCRIPTION OF THE SEVERAL VIEWS OF THE DRAWING

FIG. 1 is a view showing an outline of the arrangement of a parallel processor according to an embodiment of the present invention;

FIG. 2 is a view showing an instruction form of the parallel processor according to the embodiment of the present invention;

FIG. 3 is a block diagram of a pipeline operation of composite arithmetic of the parallel processor according to the embodiment of the present invention;

FIG. 4 is a timing chart showing a composite arithmetic operation performed by one pipeline arithmetic unit according to the embodiment of the present invention;

FIG. 5 is a timing chart showing a pipeline operation of composite arithmetic performed by two pipeline arithmetic units according to the embodiment of the present invention;

FIG. 6 is a block diagram showing a pipeline operation of composite arithmetic performed by two pipeline arithmetic units according to the embodiment of the present invention;

FIG. 7 is a timing chart showing a pipeline operation of composite arithmetic performed by two pipeline arithmetic units according to the embodiment of the present invention;

FIG. 8 is a view showing the way a sync control unit according to the embodiment of the present invention controls pipeline connection; and

FIG. 9 is a schematic view of state machines provided in the sync control unit according to the embodiment of the present invention.

### DETAILED DESCRIPTION OF THE INVENTION

An embodiment of the present invention will be explained below with reference to the accompanying drawing. In the following explanation, the same reference numerals denote the same parts throughout the drawing.

### [1] Arrangement of Parallel Processor

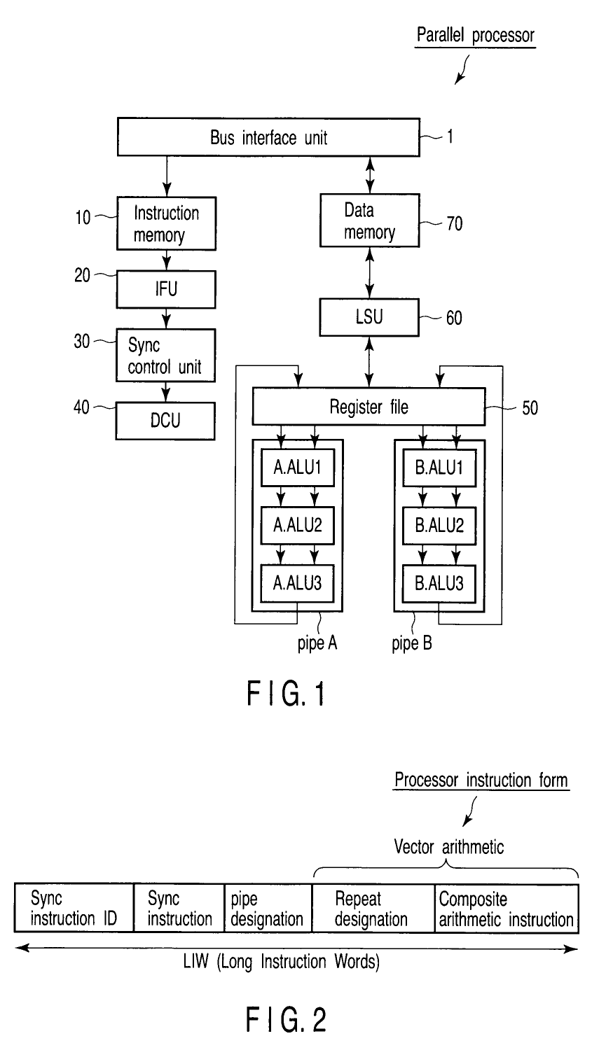

FIG. 1 is a view showing an outline of the arrangement of a parallel processor according to an embodiment of the present invention. The outline of the arrangement of the parallel processor according to the embodiment of the present invention will be explained below.

As shown in FIG. 1, this parallel processor comprises a bus interface unit 1, instruction memory 10, instruction fetch unit (IFU) 20, sync control unit 30, decoder control unit (DCU) 40, register file 50, load store unit (LSU) 60, data memory 70, and pipeline arithmetic units pipe A and pipe B.

The bus interface unit 1 exchanges instructions and data with a main memory and the like. The instruction memory 10 is an instruction cache memory, and temporarily stores a processor instruction received from the bus interface unit 1. The instruction fetch unit 20 fetches the processor instruction. The decoder control unit 40 decodes the processor instruction, and outputs a control signal to the pipeline arithmetic units pipe A and pipe B.

The pipeline arithmetic units pipe A and pipe B respectively have arithmetic and logic units (ALUs) A.ALU1 to A.ALU3 and B.ALU1 to B.ALU3. The pipeline arithmetic units pipe A and pipe B perform composite arithmetic in accordance with the processor instruction decoded by the decoder control unit 40. Note that the numbers of the arithmetic and logic units A.ALU1 to A.ALU3 and B.ALU1 to B.ALU3 are not limited to three and need only be two or more.

The register file 50 has internal registers, and temporarily stores data to be supplied to the pipeline arithmetic units pipe A and pipe B, and the results of composite arithmetic performed by these pipeline arithmetic units.

The sync control unit 30 is equipped between the instruction fetch unit 20 and decoder control unit 40. The sync control unit 30 controls the execution start timing of the pipeline connection between the pipeline arithmetic units pipe A and pipe B.

The load store unit 60 controls data transfer between the data memory 70 and register file 50. More specifically, when the processor instruction decoded by the decoder control unit 40 is a load instruction, data is transferred from the data memory 70 to the register file 50. When the processor instruction is a store instruction, data is transferred from the register file 50 to the data memory 70. The data memory 70 is a data cache memory, and temporarily stores data received from the bus interface unit 1 and data to be transmitted to the bus interface unit 1.

### [2] Instruction Form of Parallel Processor

FIG. 2 shows an instruction form of the parallel processor according to the embodiment of the present invention. The instruction form of the parallel processor according to the embodiment of the present invention will be explained below.

As shown in FIG. 2, the instruction form of the processor has a sync instruction ID, sync instruction, pipe designation, repeat designation, and composite arithmetic instruction. The instruction form of the process thus includes a plurality of fields. This instruction form is called an LIW (Long Instruction Words) instruction because the instruction bit length is long when a plurality of fields are combined.

When expressing this processor instruction by an assembly language, the instruction is described by attaching a colon (:) or semicolon (;) as a symbol for discriminating the break of an instruction field as follows.

Sync instruction ID: sync instruction; pipe designation; repeat designation; composite arithmetic instruction;

A composite arithmetic instruction with repeat designation will be called a vector arithmetic instruction. This vector arithmetic instruction implements, e.g., the following processing by one instruction.

for (i=0; i<4; i++) {
x[i] = a[i] * 11 + b[i];
}

Note that the composite arithmetic instruction may also be SIMD (Single Instruction Multiple Data) arithmetic. This SIMD arithmetic executes, e.g., the following double loops by a single LIW instruction.

```
for (i=0; i<4; i++) {
    for (j=0; j<8; j++) { /* SIMD parallel direction
    */
        x[i*8+j] = a[i*8+j] * 11 + b[i*8+j];
    }
}
```

In the above example, loops that rotate by a variable j are executed parallel by SIMD arithmetic. Note that in the following description, an explanation of this SIMD arithmetic loop will be omitted.

The sync instruction ID and the sync instruction are an instruction to synchronize two arithmetic operations.

### [3] Pipeline Operation of Composite Arithmetic

### [3-1] Composite Arithmetic

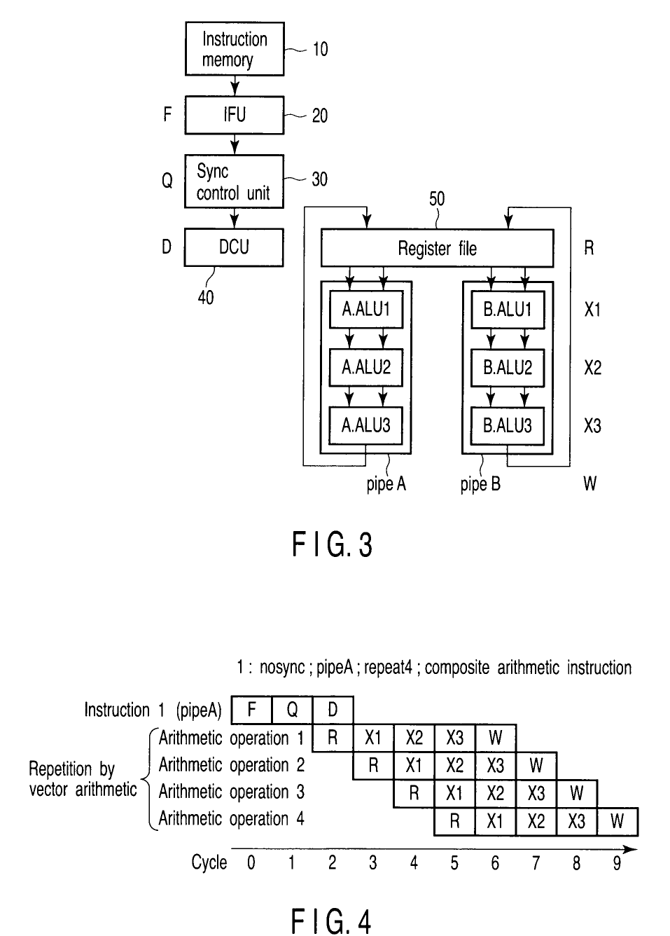

FIG. 3 is a block diagram showing a pipeline operation of composite arithmetic of the parallel processor according to the embodiment of the present invention. FIG. 4 is a timing chart showing a composite arithmetic operation performed by one pipeline arithmetic unit according to the embodiment of the present invention. Composite arithmetic performed by one pipeline arithmetic unit in the parallel processor according to the embodiment of the present invention will be explained below.

Referring to FIGS. 3 and 4, the meanings of symbols in pipeline stages are as follows.

F: Instruction fetch

Q: Synchronous queuing

D: Decode

R: Register fetch

X1, X2, X3: Execute

W: Write back

As shown in FIGS. 3 and 4, a composite arithmetic instruction in which sync instruction ID=1, sync instruction=none (nosync), pipe designation=pipeline arithmetic unit pipe A, repeat designation=4 times (repeat 4) is executed as follows. Note that in this example, the sync instruction is none because the pipeline arithmetic unit pipe A alone is used and this eliminates the need to perform synchronous control on a plurality of pipeline arithmetic units.

First, the instruction fetch unit 20 fetches the composite arithmetic instruction (F). Then, the sync control unit 30 performs synchronous queuing (Q), and the decoder control unit 40 decodes the composite arithmetic instruction. The register file 50 performs register fetch (R) simultaneously with this decoding. Subsequently, the arithmetic and logic units A.ALU1, A.ALU2, and A.ALU3 of the pipeline arithmetic unit pipe A repeat arithmetic operations 1 to 4 four times.

More specifically, arithmetic operation 1 is executed in the order of register fetch (R) by the register file 50, instruction execution (X1) by the arithmetic and logic unit A.ALU1, instruction execution (X2) by the arithmetic and logic unit A.ALU2, instruction execution (X3) by the arithmetic and logic unit A.ALU3, and write back (W) to the register file 50.

Register fetch (R) of arithmetic operation 2 is performed simultaneously with instruction execution (X1) by the arithmetic and logic unit A.ALU1 of arithmetic operation 1. Similar to arithmetic operation 1, arithmetic operation 2 is also executed in order by the arithmetic and logic units A.ALU1, A.ALU2, and A.ALU3 (X1, X2, and X3), and write back (W) to the register file 50 is performed.

Register fetch (R) of arithmetic operation 3 is performed simultaneously with instruction execution (X1) by the arithmetic and logic unit A.ALU1 of arithmetic operation 2. Similar to arithmetic operation 1, arithmetic operation 3 is also executed in order by the arithmetic and logic units A.ALU1, A.ALU2, and A.ALU3 (X1, X2, and X3), and write back (W) to the register file 50 is performed.

Register fetch (R) of arithmetic operation 4 is performed simultaneously with instruction execution (X1) by the arithmetic and logic unit A.ALU1 of arithmetic operation 3. Similar to arithmetic operation 1, arithmetic operation 4 is also executed in order by the arithmetic and logic units A.ALU1, A.ALU2, and A.ALU3 (X1, X2, and X3), and write back (W) to the register file 50 is performed.

Note that the number of execution stages is three in this example, but any number of stages can be used. Note also that one repetition by vector arithmetic is executed by a throughput of one cycle. One LIW instruction can be fetched in every cycle.

### [3-2] Parallel Execution of Composite Arithmetic

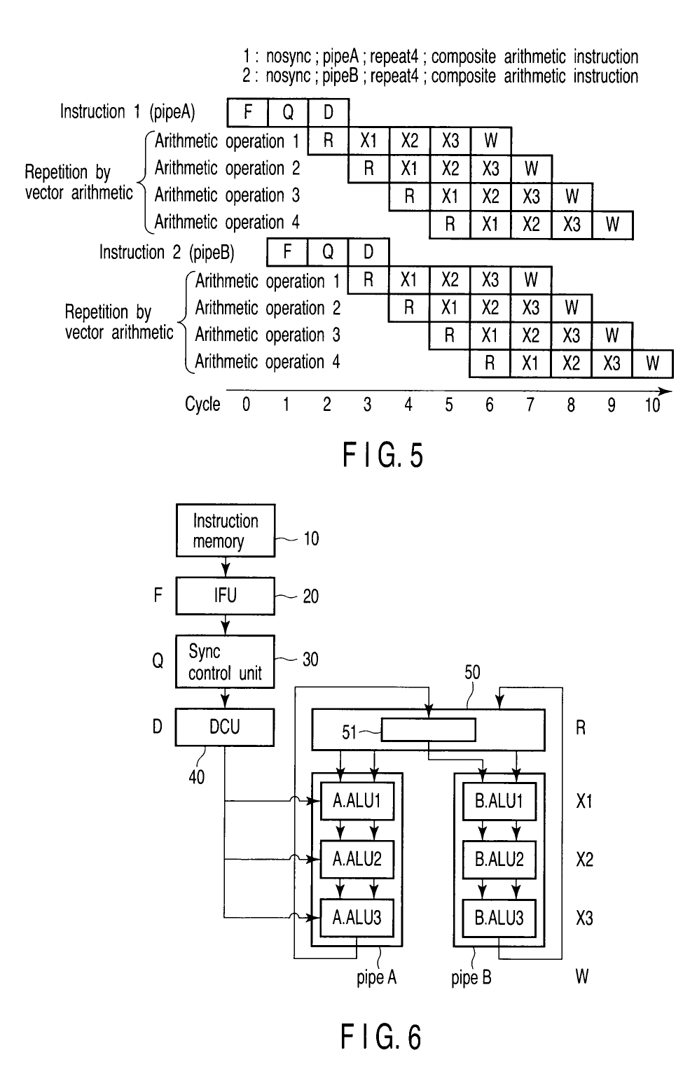

FIG. 5 is a timing chart showing a pipeline operation of composite arithmetic performed by two pipeline arithmetic units according to the embodiment of the present invention. An example of the pipeline operation of composite arithmetic performed by two pipeline arithmetic units in the parallel processor according to the embodiment of the present invention will be explained below.

This embodiment uses the pipeline arithmetic units pipe A and pipe B that perform composite arithmetic. If the pipeline arithmetic units pipe A and pipe B are independent of each other, a plurality of vector arithmetic operations can be executed parallel by using the pipeline arithmetic units pipe A and pipe B. An example is as follows.

```
for (i=0; i<4; i++) {
    x[i] = a[i] * 11 + b[i]; /* execute by pipe A */
}
for (i=0; i<4; i++) {
    y[i] = d[i] * 13 + e[i]; /* execute by pipe B */
}
```

If the array variables are independent of each other in the above example, the above example can be interpreted into the following LIW instruction. Note that no sync instruction is described because no sync instruction has been taken into consideration yet in this stage.

pipe A; repeat 4; muli_add $8+, $0+, $4+, 11;

pipe B; repeat 4; muli_add $20+, $12+, $16+, 13;

Each number starting with $ represents the register number in the register file 50. + immediately after this register number represents automatic increment of the register number.

FIG. 5 shows an example of the above-mentioned parallel execution performed by the pipeline arithmetic units pipe A and pipe B without any sync instruction. Assuming that one LIW instruction can be fetched in every cycle, an overhead of one cycle is added for instruction fetch (F) as shown in FIG. 5. However, two vector arithmetic operations can be executed by excluding this overhead.

Note that for the descriptive simplicity, only parallel execution by the two pipeline arithmetic units pipe A and pipe B has been described above. However, parallel execution is similarly possible even when the number of pipeline arithmetic units is three or more.

### [3-3] Synchronous Control

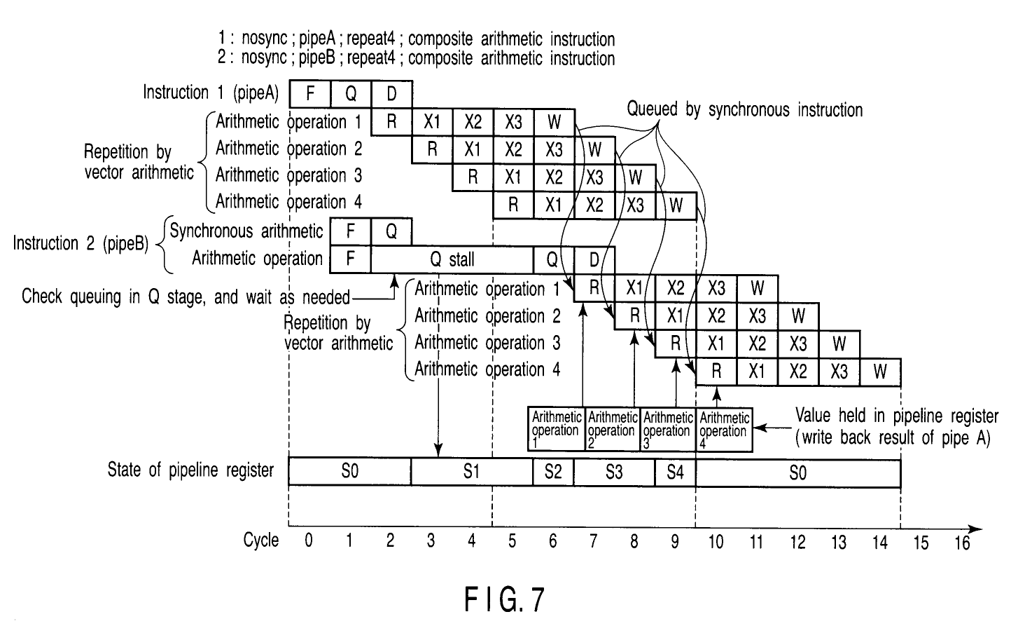

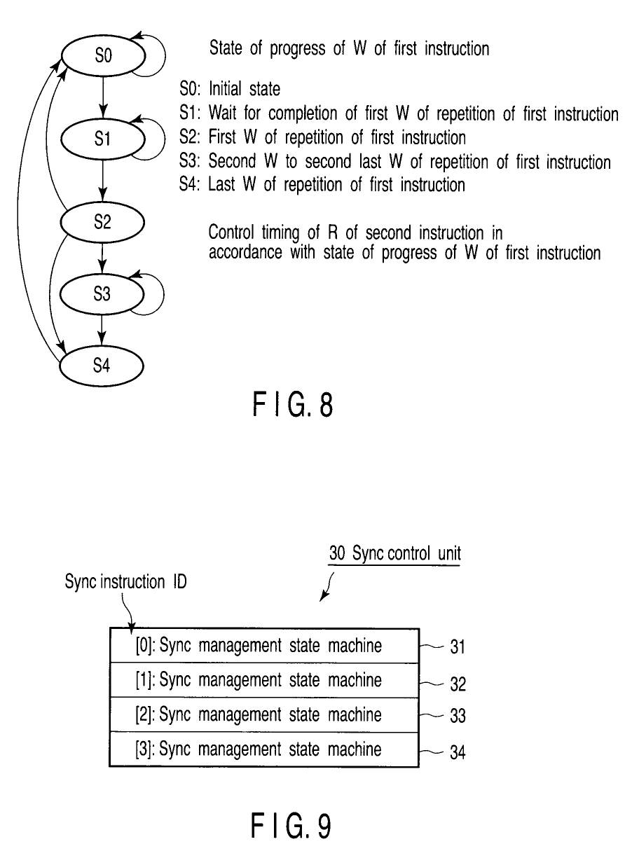

FIG. 6 is a block diagram showing a pipeline operation of composite arithmetic performed by two pipeline arithmetic units according to the embodiment of the present invention. FIG. 7 is a timing chart showing the pipeline operation of composite arithmetic performed by the two pipeline arithmetic units according to the embodiment of the present invention. FIG. 8 is a view showing the way the sync control unit according to the embodiment of the present invention controls the pipeline connection. Synchronous control of the two pipeline arithmetic units in the pipeline operation of composite arithmetic according to the embodiment of the present invention will be explained below.

As it is estimated from the example explained in [3-2], when two vector arithmetic operations are executed parallel by the pipeline arithmetic units pipe A and pipe B, the number of registers to be simultaneously used increases. The number of registers has a large effect on the cost and power consumption of the parallel processor. Accordingly, the number of registers to be simultaneously used is desirably as small as possible.

As a method of solving this problem, therefore, this embodiment performs control such that the first register fetch of the repetition of an instruction (in this example, an instruction of the pipeline arithmetic unit pipe B) in the back stage of the pipeline connection is started from a cycle immediately after the completion of the first write back of the repetition of an instruction (in this example, an instruction of the pipeline arithmetic unit pipe A) in the front stage of the pipeline connection.

An example of this control is as follows.

for (i=0; i<4; i++) {
y[i] = d[i] * 13 + a[i] * 11 + b[i];
}

The expression in the above loop is divided into two portions, and these two portions are allocated to the pipeline arithmetic units pipe A and pipe B.

```
for (i=0; i<4; i++) {
    x[i] = a[i] * 11 + b[i]; /* execute by pipe A */
}
for (i=0; i<4; i++) {
    y[i] = d[i] * 13 + x[i]; /* execute by pipe B */
}
```

The above expression can be directly interpreted into an LIW instruction as follows.

pipe A; repeat 4; muli_add $8+, $0+, $4+, 11;

pipe B; repeat 4; muli_add $16+, $12+, $8+, 13;

Four registers $8, $9, $10, and $11 are allocated to a variable x[i]. To decrease the number of the registers, therefore, the above expression is deformed as follows.

```
for (i=0; i<4; i++) {
    tmp = a[i] * 11 + b[i]; /* execute by pipe A */
    y[i] =d[i] * 13 + tmp; /* execute by pipe B */
}
```

Only one register is allocated to a variable tmp. This expression can be interpreted into an LIW instruction as follows. Note that the synchronization of reference to the variable tmp will be explained later.

pipe A; repeat 4; muli_add $8, $0+, $4+, 11;

pipe B; repeat 4; muli_add $13+, $9+, $8, 13;

When performing pipeline processing, bypass control may be used as a mechanism for transmitting the variable tmp from the pipeline arithmetic unit pipe A to the pipeline arithmetic unit pipe B. However, if the number of pipelines and the number of stages are large, the size of a bypass circuit from each stage of each pipeline arithmetic unit increases. This increases the cost and power consumption.

In this embodiment, therefore, after the operation result from the pipeline arithmetic unit pipe A is written back to the register file 50, the written back operation result is read out from the register file 50 in the reference of the pipeline arithmetic unit pipe B. Also, to simplify this control, a dedicated sync instruction for designating this synchronization is prepared.

More specifically, the following LIW instructions are prepared for the above example.

1: pipe A; repeat 4; muli_add $8, $0+, $4+, 11;

sync 1; pipe B; repeat 4; muli_add $13+, $9+, $8, 13;

1: in the starting position of the first LIW instruction represents the sync instruction ID. sync 1; in the starting position of the second LIW instruction represents the synchronization of reference to the instruction result of sync instruction ID=1.

To execute the LIW instructions as described above, the parallel processor of this embodiment comprises the sync control unit 30 between the instruction fetch stage (F) and register fetch stage (R) as shown in FIG. 6. In accordance with the sync instruction described above, the sync control unit 30 performs control to queue the connection of the pipeline arithmetic unit pipe B to be connected later, and controls the execution start timing of an instruction using the pipeline arithmetic unit pipe B. In this case, one register in the register file 50 is used as the pipeline register 51. The pipeline register 51 connects the two pipeline arithmetic units pipe A and pipe B in accordance with a control signal from the sync control unit 30.

The execution start timing of the pipeline arithmetic unit pipe B is a timing at which only one pipeline register 51 need be secured in the register file 50. That is, control is performed such that the first register fetch of the repetition of an instruction (in this example, an instruction of the pipeline arithmetic unit pipe B) in the back stage of the pipeline connection is started from a cycle immediately after the completion of the first write back of the repetition of an instruction (in this example, an instruction of the pipeline arithmetic unit pipe A) in the front stage of the pipeline connection. In the rest of the repetition after that, control is similarly performed so as to maintain the relationship by which the written back value is read out in an immediately succeeding cycle.

This composite arithmetic control will be explained in detail below with reference to FIG. 7. This control uses the two pipeline arithmetic units pipe A and pipe B, and repeats the composite arithmetic four times. In the pipeline connection, the pipeline arithmetic unit pipe A is the front stage, and the pipeline arithmetic unit pipe B is the back stage.

First, instruction 1 for the pipeline arithmetic unit pipe A is executed as follows. The instruction fetch unit 20 fetches instruction 1 (F). The sync control unit 30 performs synchronous queuing (Q), and the decoder control unit 40 decodes instruction 1 (D). Simultaneously with this decoding, the register file 50 performs register fetch (R). Then, arithmetic operation 1 is executed in the order of instruction execution (X1) by the arithmetic and logic unit A.ALU1, instruction execution (X2) by the arithmetic and logic unit A.ALU2, instruction execution (X3) by the arithmetic and logic unit A.ALU3, and write back (W) to the register file 50. Register fetch (R) of arithmetic operation 2 is performed simultaneously with instruction execution (X1) by the arithmetic and logic unit A.ALU1 of arithmetic operation 1. Similar to arithmetic operation 1, arithmetic operation 2 is executed in order by the pipeline arithmetic units A.ALU1, A.ALU2, and A.ALU3 (X1, X2, and X3), and write back (W) to the register file 50 is performed. The pipeline arithmetic unit pipe A executes arithmetic operations 1 to 4 as described above in accordance with instruction 1.

The instruction fetch unit 20 fetches (F) instruction 2 for the pipeline arithmetic unit pipe B simultaneously with synchronous queuing (Q) of instruction 1. Then, the sync control unit 30 checks whether to perform synchronous queuing (Q). The pipeline arithmetic unit pipe B waits (Q stall) until write back (W) of arithmetic operation 1 of instruction 1 is complete. On the other hand, when write back (W) of arithmetic operation 1 of instruction 1 is complete, the result of arithmetic operation 1 of the pipeline arithmetic unit pipe A is held in the pipeline register 51 of the register file 50. Therefore, this operation result is read out from the register file 50, and arithmetic operation 1 of the pipeline arithmetic unit pipe B is started. Analogously, arithmetic operation 2 of the pipeline arithmetic unit pipe B refers to the result of arithmetic operation 2 of the pipeline arithmetic unit pipe A, arithmetic operation 3 of the pipeline arithmetic unit pipe B refers to the result of arithmetic operation 3 of the pipeline arithmetic unit pipe A, and arithmetic operation 4 of the pipeline arithmetic unit pipe B refers to the result of arithmetic operation 4 of the pipeline arithmetic unit pipe A.

In the composite arithmetic as described above, the state of the pipeline register 51 changes in the order of S0, S1, S2, S3, S4, and S0 as shown in FIG. 7. Cycles 0 to 2 are in state S0. Cycles 3 to 5 are in state S1. Cycle 6 is in state S2. Cycles 7 and 8 are in state S3. Cycle 9 is in state S4. Cycles 10 to 14 are in state 0.

As shown in FIG. 8, the state of the pipeline register 51 changes in accordance with the progress of write back of the pipeline arithmetic unit pipe A. Details are as follows.

First, the pipeline register 51 is in initial state S0 until an arithmetic operation of the first instruction is started. That is, in the example shown in FIG. 7, the pipeline register 51 is in initial state S0 until execution (X1) of arithmetic operation 1 of instruction 1 is started.

When the arithmetic operation of the first instruction is started, the pipeline register 51 changes to state S1. State S1 continues to a cycle immediately before the first write back of the repetition of the first instruction is performed. That is, in the example shown in FIG. 7, state S1 continues from the start of execution (X1) of arithmetic operation 1 of instruction 1 to a cycle immediately before the start of write back (W) of arithmetic operation 1.

Subsequently, the pipeline register 51 changes to state S2 in a cycle in which the first write back of the repetition of the first instruction is performed. The pipeline register 51 stays in state S2 in only one cycle, and changes to another state in the next cycle. That is, in the example shown in FIG. 7, only a cycle in which write back (W) of arithmetic operation 1 of instruction 1 is performed is in state S2.

The pipeline register 51 changes to state S3 after the first write back of the repetition of the first instruction. State S3 continues from the second write back to the second last write back of the repetition of the first instruction. That is, in the example shown in FIG. 7, state S3 continues from write back (W) of arithmetic operation 2 of instruction 1 to write back (W) of arithmetic operation 3 of instruction 1. Simultaneously with this change to state S3, the pipeline register 51 starts the first register fetch (R) of the repetition of the second instruction. That is, in the example shown in FIG. 7, the pipeline register 51 starts register fetch (R) of arithmetic operation 1 of instruction 2.

The pipeline register 51 changes to state S4 in a cycle in which the last write back of the repetition of the first instruction is performed. The pipeline register 51 stays in state S4 in only one cycle, and changes to another state in the next cycle. That is, in the example shown in FIG. 7, only a cycle in which write back (W) of arithmetic operation 4 of instruction 1 is performed is in state S4.

The pipeline register 51 returns to state S0 after the last write back of the repetition of the first instruction. That is, in the example shown in FIG. 7, the pipeline register 51 changes to state S0 in a cycle immediately after write back (W) of arithmetic operation 4 of instruction 1. Simultaneously with this change to state S0, the pipeline register 51 performs the last register fetch (R) of the repetition of the second instruction. That is, in the example shown in FIG. 7, the pipeline register 51 performs register fetch (R) of arithmetic operation 4 of instruction 2.

As described above, the pipeline connection between the pipeline arithmetic units is performed by controlling the timing of register fetch (R) of the second instruction in accordance with the progress of write back (W) of the first instruction.

Note that in FIG. 8, a loop returning from state S2 to state S0 indicates processing when vector arithmetic is performed once. A loop jumping from state S2 to state S4 indicates processing when vector arithmetic is performed twice. A loop returning from each of states S0, S1, and S3 to itself indicates that the condition for the advancement to the next state has failed.

### [3-4] State Machines

FIG. 9 is a schematic view showing state machines provided in the sync control unit according to the embodiment of the present invention. Examples of state machines for performing synchronous control of this embodiment will be explained below.

A state machine of the sync control unit 30 shown in FIG. 9 controls states S0, S1, S2, S3, and S4 of the pipeline register 51 described above. This state machine controls the timing of register fetch (R) of instruction 2 of the second pipeline arithmetic unit pipe B in accordance with state S0, S1, S2, S3, or S4 of the progress of write back (W) of instruction 1 of the first pipeline arithmetic unit pipe A.

As shown in FIG. 9, the sync control unit 30 includes sync management state machines 31, 32, 33, and 34. The sync control unit 30 has state machines equal in number to possible sync instruction IDs. That is, this embodiment uses only two pipeline arithmetic units pipe A and pipe B. Generally, however, the number of pipeline arithmetic units can be larger. In this case, the number of instructions as objects of synchronous control can be two or more. In such a case, two bits or more are allocated to the field of sync instruction IDs in the LIW instruction, and sync management state machines equal in number to the sync instruction IDs are prepared.

When receiving an instruction with a sync instruction ID, the sync control unit 30 activates a sync management state machine corresponding to the sync instruction ID. That is, when receiving an instruction in which sync instruction ID=0, the sync control unit 30 activates the sync management state machine 31. Also, when receiving a sync instruction, the sync control unit 30 controls the start of execution of the second pipeline arithmetic unit pipe B by checking a sync management state machine corresponding to a sync instruction ID designated by the operand.

The sync management state machine is a machine to synchronize.

### [4] Effects

The parallel processor of the embodiment of the present invention comprises the sync control unit 30 between the instruction fetch unit 20 and decoder control unit 40. The sync control unit 30 performs control so as to queue the connection of the pipeline arithmetic unit pipe B, which is connected later, of the pipeline arithmetic units pipe A and pipe B, and controls the start timing of an execution instruction of the pipeline arithmetic unit pipe B. More specifically, after the operation result of the pipeline arithmetic unit pipe A is written back, the written back result is read out from the register file 50, and the pipeline arithmetic unit pipe B refers to the readout result. The pipeline register 51 in the register file 50 performs the pipeline connection between the pipeline arithmetic units pipe A and pipe B. Therefore, even when the pipeline arithmetic units pipe A and pipe B execute two vector arithmetic operations parallel, one pipeline arithmetic unit 51 is used at a time. Accordingly, unlike in the conventional apparatus, it is possible to avoid the increase in number of registers to be simultaneously used when executing vector arithmetic operations parallel.

As described above, this embodiment can control parallel execution by the pipeline connection between many pipeline arithmetic units by adding only the sync control unit 30 having a small scale. This makes it possible to improve the performance of parallel processing while reducing the cost and power consumption.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A parallel processor comprising:
a fetch unit configured to hold a processor instruction having a composite arithmetic instruction with repeat designation and a sync instruction;
a decoder unit configured to decode the processor instruction;
a plurality of pipeline arithmetic units configured to execute arithmetic operations parallel on the basis of the composite arithmetic instruction, pipeline connection between the pipeline arithmetic units being controlled in accordance with the sync instruction; and
a sync control unit equipped between the fetch unit and the decoder unit, and configured to control an execution start timing of the pipeline connection between the pipeline arithmetic units in accordance with the sync instruction.

2. The processor according to claim 1, wherein
the pipeline arithmetic units comprise a front pipeline arithmetic unit and a back pipeline arithmetic unit, and
the sync control unit controls the pipeline connection in accordance with progress of write back of the front pipeline arithmetic unit.

3. The processor according to claim 1, wherein
the pipeline arithmetic units comprise a front pipeline arithmetic unit and a back pipeline arithmetic unit, and
the sync control unit waits for write back of an operation result of the front pipeline arithmetic unit, and controls start of execution of the back pipeline arithmetic unit by referring to the written back operation result.

4. The processor according to claim 1, wherein
the pipeline arithmetic units comprise a front pipeline arithmetic unit and a back pipeline arithmetic unit, and
first register fetch of a repeat instruction of the back pipeline arithmetic unit is started from a cycle immediately after completion of first write back of a repeat instruction of the front pipeline arithmetic unit.

5. The processor according to claim 1, in which the pipeline arithmetic units comprise a front pipeline arithmetic unit and a back pipeline arithmetic unit, and
which further comprises a pipeline register configured to hold an operation result of the front pipeline arithmetic unit, and perform the pipeline connection between the front pipeline arithmetic unit and the back pipeline arithmetic unit.

6. The processor according to claim 5, wherein before execution of the back pipeline arithmetic unit is started, the operation result of the front pipeline arithmetic unit is read out from the pipeline register.

7. The processor according to claim 1, wherein
the processor instruction further has a sync instruction ID, and
the sync control unit has a state machine corresponding to the sync instruction ID.

8. The processor according to claim 7, wherein the state machine controls start of execution of the pipeline connection.

9. The processor according to claim 1, further comprising a register file having a plurality of registers, and configured to temporarily store the composite arithmetic instruction to be supplied to the pipeline arithmetic units and results of composite arithmetic performed by the pipeline arithmetic units.

10. An arithmetic method of a parallel processor which has a sync control unit equipped between the fetch unit and the decoder unit, comprising:
causing the fetch unit to fetch a first instruction for a first pipeline arithmetic unit;
causing the sync control unit to perform synchronous queuing of the first instruction;
causing the decoder unit to decode the first instruction, and a register file to fetch the first instruction;
causing the first pipeline arithmetic unit to execute a plurality of arithmetic operations parallel on the basis of the first instruction;
causing the fetch unit to fetch a second instruction for a second pipeline arithmetic unit simultaneously with the synchronous queuing of the first instruction; and
causing the sync control unit to control an execution start timing of pipeline connection with the second pipeline arithmetic unit.

11. The method according to claim 10, wherein in the causing the sync control unit to control an execution start timing of pipeline connection, the sync control unit checks whether the second instruction is synchronous queuing.

12. The method according to claim 10, wherein the sync control unit controls the pipeline connection in accordance with progress of write back of the first pipeline arithmetic unit.

13. The method according to claim 10, wherein the sync control unit waits for write back of an operation result of the first pipeline arithmetic unit, and controls start of execution of the second pipeline arithmetic unit by referring to the written back operation result.

14. The method according to claim 10, wherein first register fetch of a repeat instruction of the second pipeline arithmetic unit is started from a cycle immediately after completion of first write back of a repeat instruction of the first pipeline arithmetic unit.

15. The method according to claim 10, wherein a pipeline register of the register file holds an operation result of the first pipeline arithmetic unit, and performs the pipeline connection between the first pipeline arithmetic unit and the second pipeline arithmetic unit.

16. The method according to claim 15, wherein before execution of the second pipeline arithmetic unit is started, the operation result of the first pipeline arithmetic unit is read out from the pipeline register.

17. The method according to claim 10, wherein
each of the first instruction and the second instruction has a composite arithmetic instruction with repeat designation, a sync instruction, and a sync instruction ID, and
the sync control unit has a state machine corresponding to the sync instruction ID.

18. The method according to claim 17, wherein the state machine controls start of execution of the pipeline connection.

19. The method according to claim 10, wherein each of the first instruction and the second instruction has a composite arithmetic instruction with repeat designation and a sync instruction.

20. The method according to claim 19, wherein the composite arithmetic instruction is one of a vector arithmetic instruction and SIMD arithmetic.
